(19) United States
(12) Patent Application Publication
(10) Pub. No.: US 2023/0397571 A1
(43) Pub. Date: Dec. 14, 2023

(54) Pet Enclosure Cover

(71) Applicant: Caroline Matthews, Raleigh, NC (US)

(72) Inventor: Caroline Matthews, Raleigh, NC (US)

(21) Appl. No.: 18/316,187

(22) Filed: May 11, 2023

Related U.S. Application Data
(60) Provisional application No. 63/341,249, filed on May 12, 2022.

(51) Int. Cl. A01K 1/03

(52) U.S. Cl. CPC A01K 1/034

(57) ABSTRACT

A pet enclosure cover is disclosed. The pet enclosure cover includes a top panel, a plurality of side panels, and a bottom panel for covering a pet enclosure. The top panel, plurality of side panels, and back panel are connected together via fasteners and form a cover which when placed on the pet enclosure covers the pet enclosure. The pet enclosure cover may also be secured to the pet enclosure via a strap. The strap has two ends, with one end connected to the bottom edge of one side panel and the other end connected to the bottom edge of an opposing side panel. Alternatively, the pet enclosure cover may be secured to the pet enclosure via fasteners.

### BACKGROUND OF THE INVENTION

The present invention generally relates to pet accessories, and more particularly, to a pet enclosure cover.

Some pet owners feel their pet is more comfortable in a pet enclosure with a darker interior. Pets may feel safer and/or less anxious in a closed-off space. This can be achieved by providing a pet enclosure with solid walls, but these types of enclosure provide less ventilation and the walls are permanently solid. Alternatively, providing a pet enclosure with non-solid walls, such as a wire enclosure, provides the benefit of allowing the pet owner to choose to cover or uncover the walls.

### SUMMARY OF THE INVENTION

The present invention is directed to a pet enclosure cover for covering a pet enclosure. The pet enclosure cover, according to an embodiment of the present invention, comprises a top panel, a back panel, one or more side panels, and one or more straps. The top panel corresponds to the top wall of the pet enclosure. The back panel corresponds to the back wall of the pet enclosure and has an upper edge and side edges. The back panel is supported by the top panel at its upper edge. Each of the one or more side panels corresponds to a sidewall of the pet enclosure and has an upper edge and one or more side edges. The side panels also have an upper edge and one or more side edges. The side panels are also supported by the top panel at their respective upper edges and are also supported by the back panel at their respective side edges. Each of the top, back and side panels may be made of one or more layers of the same material. Additionally, the top panel, side panels, and back panel are all connected to form a unitary covering. The top panel, side panels, and back panel may be joined by one or more fasteners, such as magnets, Velcro, hook and loop, or sewn or stitched together to form a covering having a back panel, top panel, and opposing side panels.

Opposing side panels may be joined using one or more straps having opposing ends. The one or more straps extend between the opposing side panels such that one end of the strap is connected to one of the side panels and the opposite end of the strap is connected to the opposing side panel. When the pet enclosure cover is placed on a pet enclosure, the strap is placed underneath the pet enclosure and extends between opposing side panels. The one or more straps can be made of an elastic material. The one or more straps may also be made of, or may include one or more surfaces made of, a non-slip or anti-slip material.

In another embodiment, the pet enclosure cover is secured to the pet enclosure via magnets rather than a strap. The magnets are located at one or more predetermined locations on the top panel, the back panel, and the one or more of side panels. The magnets provide a connection between the respective panels and the pet enclosure. The magnets can be magnetic snaps, sewn-in magnets, or non-sewn-in magnets. In one embodiment, a small pocket encloses the magnet and is attached to the respective panel. The pocket is a piece of material corresponding to the size of the magnet and may be attached by stitching to the panel on which it is placed.

### BRIEF DESCRIPTION OF THE DRAWINGS

The novel features and advances of the present invention will become more apparent by describing in detail exemplary embodiments with reference to the attached drawings in which:

FIG. 1 is a perspective view of the pet enclosure and the pet enclosure cover.

FIG. 2 is a perspective view of the pet enclosure and the pet enclosure cover.

FIG. 3 is a partial cross-sectional view of the pet enclosure cover embodiment shown in FIG. 2.

FIG. 4 is a perspective view of another embodiment of the pet enclosure cover shown in FIG. 1.

### DETAILED DESCRIPTION OF THE INVENTION

The present invention will now be described with reference to the accompanying figures, in which exemplary embodiments of the invention are shown. The invention may, however, be embodied in many different forms and should not be construed as being limited to the embodiments set forth herein. Rather, these embodiments are provided so that this disclosure will be thorough and complete and will fully convey the concept of the invention to those skilled in the art.

In the figures, whenever the same element reappears in subsequent figures, it is denoted by the same reference numeral.

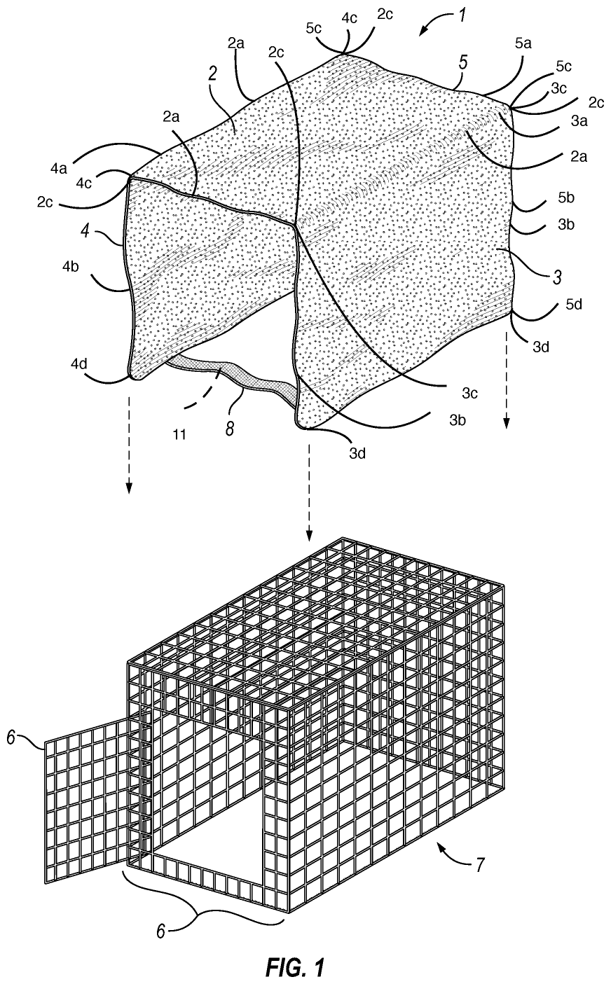

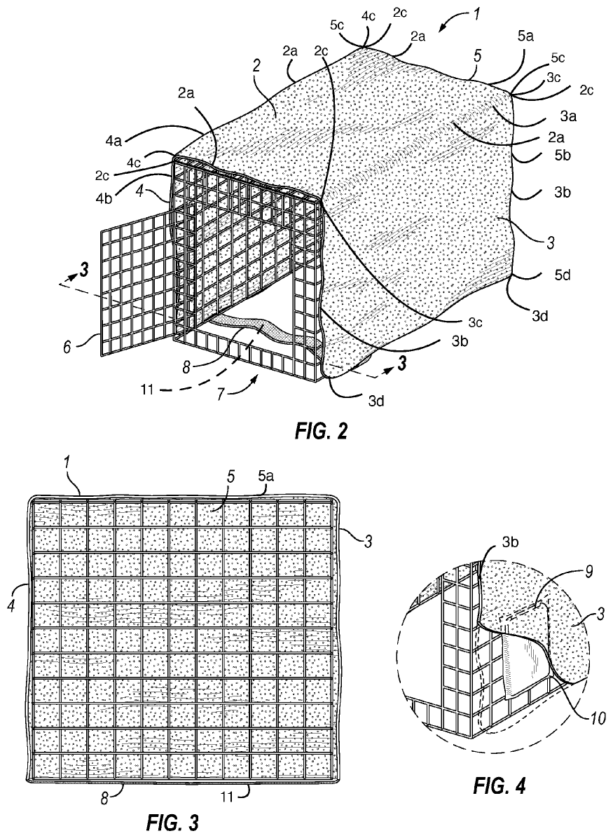

Referring to FIG. 1, FIG. 1 shows a pet enclosure cover 1 according to an embodiment of the present invention. The pet enclosure cover 1 includes a top panel 2, side panels 3 and 4, and back panels 5. As best seen in FIG. 2, the door 6 of the pet enclosure 7 is left uncovered by the pet enclosure cover 1 to allow the pet to enter and exit the pet enclosure 7. When in use, pet enclosure cover 1 is placed on a pet enclosure 7, as shown in FIG. 2. As seen in FIG. 1, the pet enclosure 7 is a three-dimensional solid shape which has six faces that are quadrilaterals and eight corners. It will be appreciated that the pet enclosure cover 1 may be structured to pet enclosures having other geometrical configurations.

The top panel 2 covers the top panel of the pet enclosure and side panels 3 and 4 and back panel 5 cover the side panels and back panel of the pet enclosure 7, respectively. The pet enclosure cover 1 of the present invention can be made of any suitable material such as textile or synthetic materials. The top panel 2 and the side panels 3 and 4 and back panel 5 may be made of the same material.

The top panel 2 includes a surrounding peripheral edge 2a. As best seen in FIG. 1, the side panels 3 and 4 each have an upper edge 3a and 4a, respectively, wherein the upper edge 3a extends between corners 3c and upper edge 4a extends between corners 4c. The side panels 3 and 4 also include one or more side edges 3b and 4b, respectively, wherein the one or more side edges 3b extends between corners 3c and 3d and the one or more side edges 4b extends between corners 4c and 4d. Back panel 5 has an upper edge 5a and one or more side edges 5b. The upper edge 5a extends between the corners 5c and the one or more side edges 5b extends between the corners 5c and 5d.

As best seen in FIG. 1, the side panels 3 and 4 are supported by the top panel peripheral edge 2a at their respective upper edges 3a and 4a, respectively, and by the back panel side edge 5b at the respective edges of the one or more side edges 3b and 4b. The back panel 5 is supported by the top panel peripheral edge 2a at its upper edge 5a and at its side edge 5b by side edge 3b of side panel 3 and by side edge 4b of side panel 4. When joined as described, the panels, 2, 3, 4, and 5 form a pet enclosure cover that defines a unitary structure having a top panel, opposing side panels, a back panel, an open front, and an open bottom.

In another embodiment, the pet enclosure cover 1 could have an extended top panel or an extended side panel, wherein the extended material forms the back panel. In an embodiment where the pet enclosure cover 1 has an extended top panel 2, the top panel peripheral edge 2a would be joined to the to upper edges 3a and 4a, respectively, and the side panel edges 3b and 4b would be joined to the extended portion of peripheral edge 2a to form a cover having top, opposing side, and back panels.

In the embodiment shown in FIGS. 1 and 2, the panels 2, 3, 4 and 5 can be joined at their respective edges by any suitable means, such as magnets, hook and loop fasteners or may be sewn or stitched together. In one embodiment, the top panel 2, the side panels 3 and 4 and back panel 5 may be secured to the pet enclosure 7 via fasteners. Fasteners can include any suitable fastener, including magnets, hook and loop, or stitching. In one embodiment, the top panel 2, the side panels 3 and 4 and back panel 5 may be separate panels and may be individually removed from the pet enclosure 7 without removing the remaining panels of the pet enclosure cover 1.

In one embodiment, the top panel 2, the side panels 3 and 4, and the back panel 5 each have two layers of material. Each panel 2, 3, 4 and 5 has an inner layer and an outer layer. The inner layer and the outer layer can be the same or different materials. The inner layer and outer layer have the same dimensions and are sewed together. In one embodiment, the outer layer may feature a decorative pattern.

In another embodiment, the top panel 2, the side panels 3 and 4, and the back panel 5 can have one or more layers of material. If there is more than one layer, the layers can be the same or different materials. If there is more than one layer, all layers can be sewn or stitched together. In one embodiment, the outermost layer may feature a decorative pattern.

Referring to FIG. 2, in one embodiment one or more straps 8 are provided to secure the pet enclosure cover 1 in place on the pet enclosure 7. In the embodiment shown in FIG. 1, strap 8 is an elongated piece of material having two opposing ends. As best seen in FIGS. 1 and 2, one end of strap 8 is supported by the bottom edge of side panel 3, and the opposing end of strap 8 is supported by the bottom edge of side panel 4. The one or more straps 8 may be supported on opposing side panels at a predetermined location. The one or more straps 8 may be supported on the opposing side panels 3 and 4 by any suitable means, such as magnets, hook and loop fasteners, or stitching. The one or more straps 8 can be made of any suitable material such as an elastic or a textile material. The one or more straps 8 may also be made of, or may include one or more surfaces made of or supporting, an anti-slip or non-slip material 11 such as rubber, vinal, foam, or plastic.

Referring now to FIGS. 2 and 4, the embodiment of the pet enclosure cover 1 shown in FIG. 4 is identical in structure, except for pocket 10, to that shown in FIG. 2. In the embodiment shown in FIG. 4, magnets 9 are used to secure the pet enclosure cover 1 to the enclosure 7. As previously described, the top panel 2, the side panels 3 and 4, and the back panel are joined together to create a unitary covering, as best seen in FIG. 1. Also, as previously described, panels 3, 4 and back panel 5 can be supported by or joined respectively to one another and to the top panel 2 by fasteners such as magnets, hook and loop, or thread stitching the respective panels together, as best seen in FIG. 1.

Referring to FIG. 4, the top panel 2, the side panels 3 and 4 and the back panel 5 are secured in place on the pet enclosure 7 via one or more magnets 9. Magnets 9 may be placed into pockets 10 sewn into top panel 2, side panels 3 and 4, and back panel 5. Pockets 10 may be sewn closed to enclose the magnets 9. In one embodiment, the magnets 9 are located on the four corners of the top panel 2, the side panels 3 and 4 and back panel 5, respectively. In one embodiment, pocket 10 is a size corresponding to the size and shape of the magnet such that the edges of the pocket 10 align with the edges of the magnet 9. Pockets 10 can be supported on the respective top, side, and back panels 2, 3, 4, and 5 by any suitable means, including being sewn onto the panels 2, 3, 4, and 5. In another embodiment, pockets 10 may be removably attached to the supporting panel by using fasteners, which may include hook and loop fasteners.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and equivalents.

What is claimed is:

1. A pet enclosure cover, comprising:
a top panel, wherein the top panel has a peripheral edge;
a back panel having an upper edge and side edges, said upper edge being adjacent to the top panel;
a plurality of side panels having an upper edge and one or more side edges, said plurality of side panels being adjacent to the top panel peripheral edge at their respective upper edges and adjacent to the back panel at the back panel side edge and the respective side panel edges of the plurality of side panels; and
one or more straps, having a first and a second end, the first end of the one or more straps being supported by one of said plurality of side panels and the second end of said one or more straps supported by an opposing side panel of said plurality of side panels.

2. The pet enclosure cover of claim 1, wherein the upper edge of the plurality of side panels is supported by the top panel peripheral edge and the one or more side edges of the plurality of side panels are supported by the back panel side edge at the respective side panel edges of the plurality of side panels.

3. The pet enclosure cover of claim 2, wherein the top panel, back panel, and the plurality of side panels are connected to each other with one or more fasteners, said fasteners being magnets, hook and loop, or stitching that sews the panels together.

4. The pet enclosure cover of claim 1, wherein the top panel, back panel and the plurality of side panels are made of one or more layers of the same material.

5. The pet enclosure cover of claim 1, wherein the straps can be elastic.

6. A pet enclosure cover, comprising:
a top panel, wherein the top panel has a peripheral edge;
a back panel having an upper edge and side edges, said back panel being adjacent to the top panel at its upper peripheral edge;
a plurality of side panels having an upper edge and one or more side edges, said plurality of side panels being adjacent to the top panel peripheral edge at the respective upper edges of the plurality of side panels, and said plurality of side panels being adjacent to the back panel at the respective side edges of said plurality of side panels;
a plurality of magnets located at a plurality of predetermined locations on the top panel, the back panel, and the plurality of side panels, wherein the plurality of magnets provides a connection between the top panel, the back panel, the plurality of side panels, and the pet enclosure.

7. The pet enclosure cover of claim 6, wherein the top panel, back panel, and the plurality of side panels are made of one or more layers of the same material.

8. The pet enclosure cover of claim 6, wherein said magnets can be magnetic snaps, sewn-in magnets, or non-sewn-in magnets.

9. The pet enclosure cover of claim 6, further comprising pockets supported by the top, back, and plurality of side panels, respectively.

10. The pet enclosure cover of claim 6, wherein the top panel, back panel, and the plurality of side panels are joined to each other with one or more fasteners, said fasteners being magnets, hook and loop, or stitching sewing the top, back, and plurality of side panels together.

11. A pet enclosure cover for covering a pet enclosure having a housing having one or more sidewalls and one or more doors, comprising:
one or more panels corresponding to the one or more housing sidewalls of the pet enclosure in shape and size, wherein the one or more panels are coupled together via fasteners; and
a means for securing the one or more panels in place along the corresponding housing sidewalls.

12. The pet enclosure cover of claim 11, wherein the one or more panels are formed of one or more layers of the same material.

13. The pet enclosure cover of claim 11, wherein the means for securing the one or more panels in place on the housing includes a strap having two opposing ends, wherein the opposing ends are supported by opposing sidewall surfaces of the housing.

14. The pet enclosure cover of claim 11, wherein the one or more panels are secured in place on the pet enclosure housing sidewalls using a plurality of magnets located at one or more predetermined locations on the one or more panels.

15. The pet enclosure cover of claim 11, wherein said fasteners can be magnets, hook and loop, or stitching sewing the respective panels together.
